(19) United States
(12) Patent Application Publication
(10) Pub. No.: US 2026/0158622 A1
(43) Pub. Date: Jun. 11, 2026

(54) CLAMPING FIXTURE

(71) Applicant: CHINA JILIANG UNIVERSITY, Zhejiang (CN)

(72) Inventor: Zhaobo Qing, Zhejiang (CN)

(21) Appl. No.: 19/073,322

(22) Filed: Mar. 7, 2025

(30) Foreign Application Priority Data
Dec. 11, 2024 (CN) 202411818218.8
Dec. 11, 2024 (CN) 202411818219.2

(51) Int. Cl. B25B 5/06

(52) U.S. Cl. CPC B25B 5/06

(57) ABSTRACT

Embodiments of the present disclosure provide a clamping fixture, the clamping fixture includes a first supporting component having a first working through hole, a second supporting component having a second working through hole and at least three clamping jaws, and a first gear portion is located at a peripheral wall of the first working through hole. A central axis of the second working through hole aligns with a central axis of the first working through hole, and the first supporting component and the second supporting component are rotatable relative to each other. The clamping jaws are rotatably connected to the second support component and uniformly arranged along a peripheral direction of the first working through hole, and in two adjacent clamping jaws, each clamping jaw has a clamping surface, a butting surface and a second gear portion, and a butting surface of one clamping jaw is adjacent to and faces a clamping surface of the other clamping jaw, so that clamping surfaces of at least three clamping jaws enclose a clamping cavity, and the first gear portion meshes with each second gear portion, so that at least three clamping jaws rotate synchronously to enlarge or narrow the clamping cavity.

### CROSS-REFERENCE TO RELATED APPLICATION

The present application claims priorities to and benefits of Chinese Patent Application No. 202411818218.8 filed on Dec. 11, 2024, and Chinese Patent Application No. 202411818219.2 filed on Dec. 11, 2024, the entire contents of which are incorporated herein by reference.

### FIELD

The present disclosure relates to a clamping fixture.

### BACKGROUND

In related technologies, a gap between clamping elements of a clamping fixture such as a three-jaw chuck is large, and the clamping fixture is prone to cause clamping deviation and jamming, resulting in the inability of automatic centering and a need of a secondary clamping by a manual operation. In addition, for a clamping fixture such as a crimping plier, although a gap between clamping elements of the clamping fixture is small, but a size range of a clamping cavity of the clamping fixture is small, so the applicability of the clamping fixture to a workpiece is poor, and the crimping plier depends on a manual operation on a plier handle causing a small clamping force, in addition, a gap between a mating groove and a crimping block of the crimping plier will enlarge due to wear, so the crimping plier cannot be used in an occasion with a high requirement of clamping accuracy.

### SUMMARY

An embodiment of the present disclosure provides a clamping fixture, the clamping fixture includes a first support component having a first working through hole, wherein a peripheral wall of the first working through hole has a first gear portion; a second support component having a second working through hole, wherein a center axis of the second working through hole is aligned with a center axis of the first working through hole, the second support component is connected to the first support component and the first support component and the second support component is configured to rotate relative to each other; and at least three clamping jaws, wherein each clamping jaws is rotatably connected to the second support component and uniformly arranged along a peripheral direction of the first working through hole, each clamping jaw has a clamping surface, a butting surface and a second gear portion, wherein in two adjacent clamping jaws, a butting surface of one clamping jaw is adjacent to and faces a clamping surface of another clamping surface so that the clamping surfaces of at least three clamping jaws enclose a clamping cavity configured for clamping a workpiece, wherein the first gear portion meshes with the second gear portion so that the at least three clamping jaws rotate synchronously to enlarge or narrow the clamping cavity when the first support component and the second support component rotate relative to each other

### BRIEF DESCRIPTION OF THE DRAWINGS

FIG. 1 is a schematic perspective view of a clamping fixture of an embodiment of the present disclosure.

FIG. 2 is an exploded view of a clamping fixture of an embodiment of the present disclosure.

FIG. 3 is a schematic perspective view of a clamping jaw of a clamping fixture of an embodiment of the present disclosure.

FIG. 4 is another schematic perspective view of a clamping jaw of a clamping fixture of an embodiment of the present disclosure.

FIG. 5 is a schematic partial sectional diagram of a clamping fixture of an embodiment of the present disclosure.

FIG. 6 is a schematic sectional diagram of a clamping fixture of an embodiment of the present disclosure.

FIG. 7 is a schematic sectional diagram of a clamping fixture along a line B-B shown in FIG. 6.

FIG. 8 is a schematic diagram of a clamping fixture of an embodiment of the present disclosure showing a clamping cavity opened to the maximum.

FIG. 9 is a schematic diagram of a clamping fixture of an embodiment of the present disclosure showing a clamping cavity closed to the minimum.

FIG. 10 is an exploded view of a clamping fixture of another embodiment of the present disclosure.

FIG. 11 is a schematic partial sectional diagram of a clamping fixture of another embodiment of the present disclosure.

FIG. 12 is another schematic partial sectional diagram of a clamping fixture of another embodiment of the present disclosure.

FIG. 13 is a schematic diagram of a clamping fixture of another embodiment of the present disclosure showing a clamping cavity opened to the maximum.

FIG. 14 is a schematic diagram of a clamping fixture of another embodiment of the present disclosure showing a clamping cavity closed to the minimum.

FIG. 15 is a schematic perspective view of a test device of an embodiment of the present disclosure.

FIG. 16 is a schematic partial perspective view of a test device of an embodiment of the present disclosure.

FIG. 17 is another schematic partial perspective view of a test device of an embodiment of the present disclosure.

FIG. 18 is an exploded diagram of a test assembly of a test device of an embodiment of the present disclosure.

FIG. 19 is a schematic sectional diagram of a test assembly of a test device of an embodiment of the present disclosure.

FIG. 20 is a schematic diagram showing a test assembly of a test device of an embodiment of the present disclosure is contacted with a contact member of a connector.

FIG. 21 is a schematic diagram showing a test assembly of a test device of another embodiment of the present disclosure is contacted with a contact member of a connector.

### DETAILED DESCRIPTION

A clamping fixture or a clamping device of an embodiment of the present disclosure is described below in connection with the accompanying drawings.

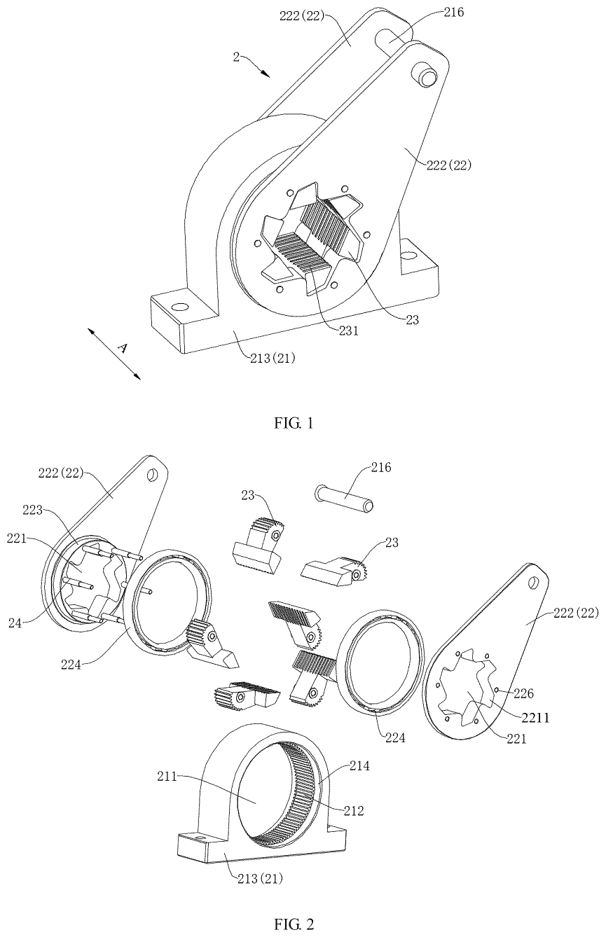

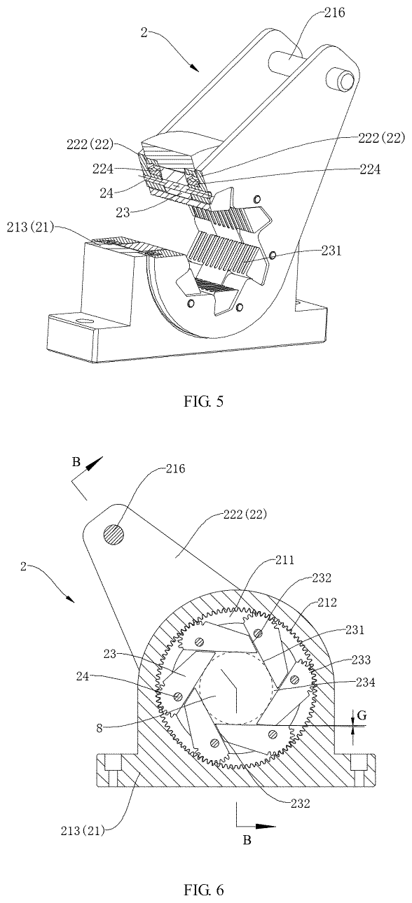

As shown in FIGS. 1-14, the clamping fixture 2 includes a first support component 21, a second support component 22, and at least three clamping jaws 23.

The first support component 21 has a first working through hole 211, and a first gear portion 212 is located at a peripheral wall of the first working through hole 211. The second support component 22 has a second working through hole 221, and a center axis of the second working through hole 221 aligns with a center axis of the first working through hole 211.

The second support component 22 is connected to the first support component 21 and rotates relative to the first support component 21. In other words, the first support component may be a fixed stationary component and the second support component is a rotating component; or the second support component is a fixed stationary component and the first support component is a rotating component; or both the first support component and the second support component are rotating components, and the rotating component may be rotated manually or driven by a drive assembly.

The clamping jaws 23 are rotatably connected to the second support component 22 and are uniformly arranged along a peripheral direction of the first working through hole 211. The clamping jaw 23 has a clamping surface 231, a butting surface 232 and a second gear portion 233. In two adjacent clamping jaws 23, a butting surface 232 of one clamping jaw 23 is adjacent to and faces a clamping surface 231 of the other clamping jaw 23, and a clamping cavity 234 for clamping a workpiece is enclosed by the clamping surfaces 231 of at least three clamping jaws 23. Preferably, the number of the clamping jaws 23 may be 3 to 6. Therefore, it can be ensured that the clamping cavity is formed and the number of the clamping jaws can be reduced, and the structure of the clamping fixture is simplified and compact to facilitate the miniaturization of the clamping fixture.

Here, the term “adjacent” refers that the butting surface of one clamping jaw may be contacted to the clamping surface of the other adjacent clamping jaw or a gap G between the butting surface of one clamping jaw and the clamping surface of the other adjacent clamping jaw is small, for example, the gap G is less than 10 millimeters, so that the enclosed clamping cavity in the peripheral direction can be referred to as substantially closed. Optionally, the gap G may be greater than or equal to zero and less than or equal to 5 millimeters. For example, the gap G may be 0, 1 mm, 1.25 mm, 2 mm, 3.8 mm, 4 mm, 4.5 mm or 5 mm.

When the gap G is 0, the butting surface of one clamping jaw is contacted to and attached to the clamping surface of the other adjacent clamping jaw and can slide relative to the clamping surface of the other adjacent clamping jaw, and the clamping cavity in the peripheral direction is substantially completely closed. When the gap G is greater than 0 and less than or equal to 5 mm, there is a gap between the butting surface of one clamping jaw and the clamping surface of the other adjacent clamping jaw.

The first gear portion 212 meshes with the second gear portion 233, and when the first support component 21 and the second support component 22 rotates relative to each other, at least three clamping jaws 23 are driven to rotate synchronously to enlarge or narrow the clamping cavity 234.

The clamping fixture of an embodiment of the present disclosure has a high clamping force, a high accuracy, a low wear and a long service life of the clamping jaw. The clamping cavity has a greater variation range in size (area) and a high applicability. For example, the clamping fixture can be used to clamp a connector and an umbrella.

In addition, at least three clamping jaws are uniformly arranged along a peripheral direction of the first working through hole, the clamping cavity is always enlarged or narrowed centering around a center axis of the first working through hole, and the clamping cavity is always in the shape of a regular polygon, and is capable to realize an automatic centering of the workpiece.

In some embodiments, the first gear portion 212 may be constructed as a complete annular inner gear ring formed at the entire peripheral wall of the first working through hole 211. Optionally, the first gear portion 212 is constructed as a plurality of inner gear ring segments spaced apart along the peripheral direction of the first working through hole 211 and corresponding to the second gear portions 233, and the number of the inner gear ring segments may be the same as the number of the second gear portions or may be fewer than the number of the second gear portions, for example, two second gear portions correspondingly mesh with one inner gear ring segment.

Preferably, the clamping surface 231 of the clamping jaw 23 has an anti-slip pattern or a clamping teeth to improve a clamping force and clamping reliability for the workpiece, so as to avoid slipping of the workpiece when the workpiece is clamped.

In some specific examples, as shown in FIGS. 1-9, the clamping fixture 2 includes six clamping jaws 23, the first support component 21 is constructed as a fixed base 213, and the second support component 22 is constructed as two pivoting arms 222.

The two pivoting arms 222 are rotatably mounted to the base 213 and are arranged at both sides of the base 213 along the axial direction of the first working through hole 211, and the clamping jaw 23 is rotatably mounted between the two pivoting arms 222 by a pivot shaft 24.

As shown in FIGS. 1-2 and FIGS. 5-6, the base 3 is substantially Q-shaped, the first working through hole 211 is a circular hole and passes through the base 213 along a thickness direction of the base 213 (direction A in FIG. 1), and the first gear portion 212 is an inner gear ring formed at the entire peripheral wall of the first working through hole 211.

As shown in FIG. 1 and FIG. 7, diameters of two ends of the first working through hole 211 enlarge to form a flared hole segment 214, in other words, the first working through hole 211 is divided into three segments, a diameter of a middle segment of the first working through hole 211 is smaller than diameters of the two end segments of the first working through hole 211, such that an annular protrusion is formed in the middle of the first working through hole 211, and the inner gear ring 12 is formed at the inner peripheral surface of the annular protrusion.

The pivoting arm 222 is plate-sharped, and a first end of the pivoting arm 222 is semicircular shaped and a width of the first end of the pivoting arm 222 is larger than a width of the second end of the pivoting arm 222. A second working through hole 221 is formed at the first end of the pivoting arm 222, and a flange 223 surrounding the second working through hole 221 is formed on a surface of the pivoting arm 222 facing the base 213, the flange 223 is rotatably fitted within the flared hole segment 214 directly or by a bearing 224, and is blocked by the annular protrusion in the middle of the first working through hole. The flared hole segment 214 and the flange 223 can limit the pivoting arm.

The clamping jaw 23 has a pivot hole 239, a first end of the pivot arm 222 has a plurality of shaft holes 226 surrounding the second working through hole 221 and passing through the flange 223, and the pivot shaft 24 penetrates through the pivot hole 239 and the shaft hole 226 so as to mount the clamping jaw 23 to the two pivot arms 222.

Optionally, a connecting shaft 216 is provided between second ends of the two pivot arms 222 to increase the overall structural stability and firmness of the two pivot arms 222. The connecting shaft 216 may be driven manually or by a drive assembly such as an electric actuator, a hydraulic cylinder, or the like, to drive two pivot arms 222 to rotate synchronously.

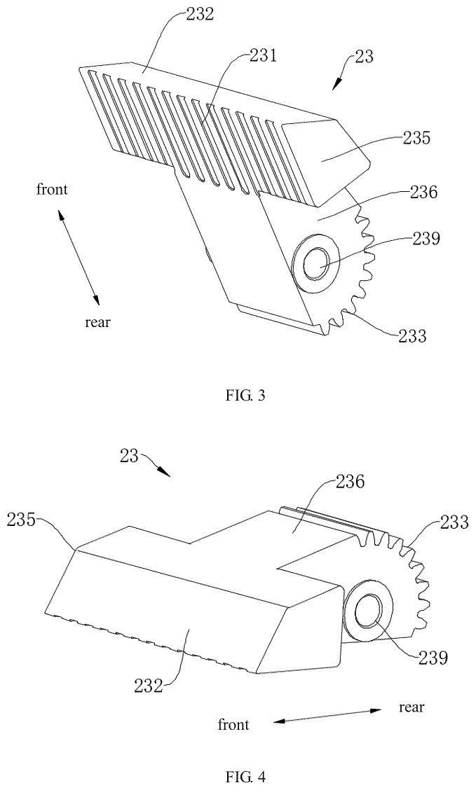

As shown in FIGS. 3-7, the clamping jaw 23 has a substantially T-shaped structure and includes a clamping head portion 235 and a shank portion 236, one end of the shank portion 236 is connected to a rear surface of the clamping head portion 235, and the second gear portion 233 is located at the other end of the shank portion 236 (i.e., a free end of the shank portion 236). Each of two ends of the clamping head portion 235 is located within the second working through hole 221 of each of the two pivot arms 222 respectively, and as shown in FIG. 2, an outer peripheral wall of the second through hole 21 has a plurality of concave portions 2211 spaced apart, and two ends of the clamping head portion 235 are formed in a shape fitted the shape of concave portions 2211.

The pivot hole 239 is arranged at the shank portion 236, an end surface of the clamping head portion 235 is substantially trapezoidal, a front surface of the clamping head portion 235 away from the shank portion 236 is formed as the butting surface 232, and a bottom surface of the clamping head portion 235 is formed as the clamping surface 231.

In other words, the clamping head portion 235 and the shank portion 236 are in a substantially T-shaped structure, and a length of the clamping head portion 235 in an axial direction of the second working through hole 221 is longer than the width of the shank portion 236, so that the clamping surface 231 of the clamping head portion 235 has a larger area, thus improving the clamping effect on the workpiece.

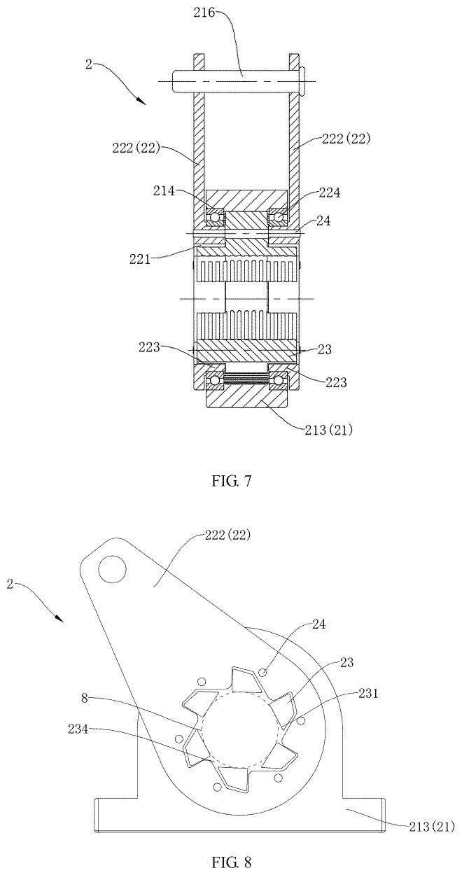

By driving the pivot arm 222 to swing along different directions, the clamping cavity 234 can be enlarged or narrowed. FIG. 8 shows a state in which the clamping cavity 234 is enlarged to the maximum, and FIG. 9 shows a state in which the clamping cavity 234 is narrowed to the minimum.

When in use, the clamping cavity 234 is opened to the maximum, the workpiece is put into the clamping cavity 234, and then the two pivot arms 222 are driven to swing synchronously relative to the base 213, and six clamping jaws 23 revolve around the centers of the first working through hole 211 and the second working through hole 221 with the pivot arms 222 and rotate around the pivot shaft 24 at the same time, and the butting surface 232 of any one of the clamping jaws moves toward the butting surface 232 of another clamping jaw relative to the clamping surface 231 of the another adjacent clamping jaw, so that the clamping cavity 234 is gradually narrowed to clamp the workpiece. When the workpiece is to be removed, the pivoting arms 222 are rotated in the opposite direction so that the clamping cavity 234 is gradually enlarged to release the workpiece.

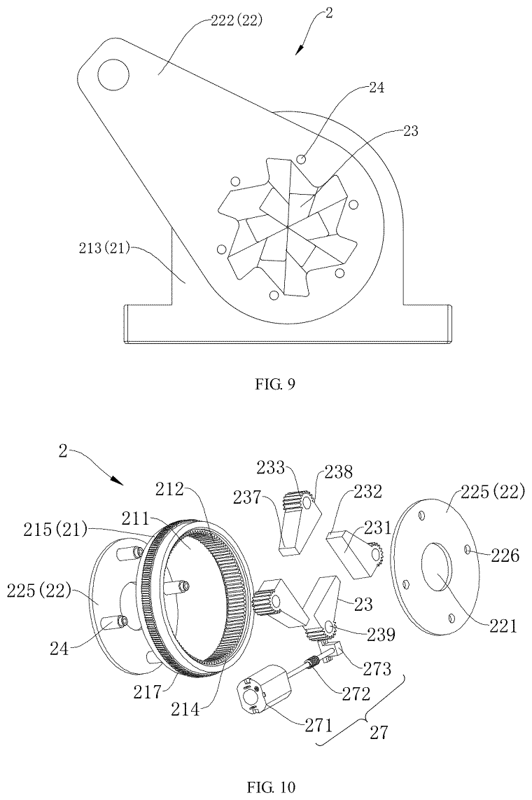

In other specific examples, as shown in FIGS. 10-14, the clamping fixture 2 includes four clamping jaws 23, the first support component is constructed as a rotating disk 215, and the second support component 22 is constructed as two fixing disks 225.

The rotating disk 215 is circular-ring shaped, the rotating disk 215 is rotatably arranged between the two fixing disks 225 along the axial direction of the first working through hole 211, and four clamping jaws 23 are rotatably mounted between the two fixing disks 225 by pivot shafts 24.

A side surface of the clamping jaw 23 is substantially trapezoidal in shape, the clamping jaw 23 has a first end 237 and a second end 238, an end surface area of the first end 237 is smaller than an end surface area of the second end 238, the end surface of the first end 237 of the clamping jaw 23 is formed as the butting surface 232, and a bottom surface of the clamping jaw 23 is formed as the clamping surface 231. The second gear portion 233 is formed at a junction of a second end surface and an upper surface of the clamping jaw 23.

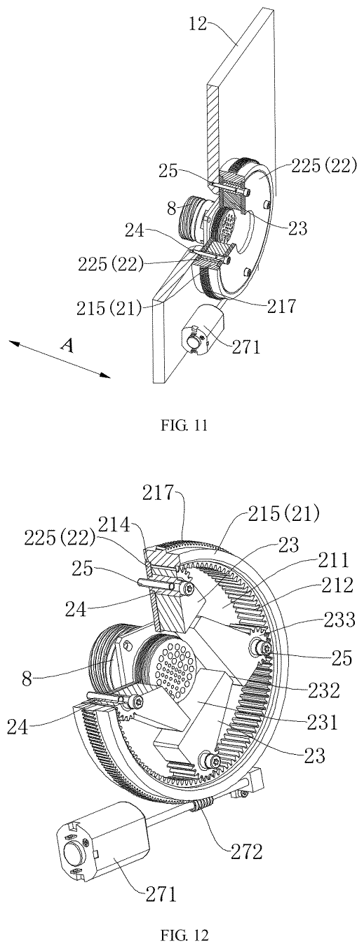

As shown in FIGS. 10 and 11, the clamping fixture 2 further includes a base plate 12 and a drive assembly 27 for driving the rotating disk 215 to rotate, the pivot shaft 24 is a hollow shaft, and two ends of the pivot shaft 24 are connected to two fixing disks 225, respectively, the fixing disk 225 is mounted to the base plate to be fixed by a fastener 25 penetrating through the fixing disks 225 and the pivot shaft 24. The base plate in embodiments may also be referred to as a side plate. By the fastener 25 arranged within the pivot shaft 24, the two fixing disks 225 can be connected together and fixed to the base plate 12, the rotating disk 215 is rotatable relative to the fixing disks 225. Optionally, the fastener 25 may be a bolt.

The drive assembly 27 includes a motor 271 and a worm 272 connected to the motor 271, and an outer peripheral wall surface of the rotating disk 215 has an outer gear ring 217 meshed with the worm 272, and the outer gear ring 217 may also be referred to as a worm gear.

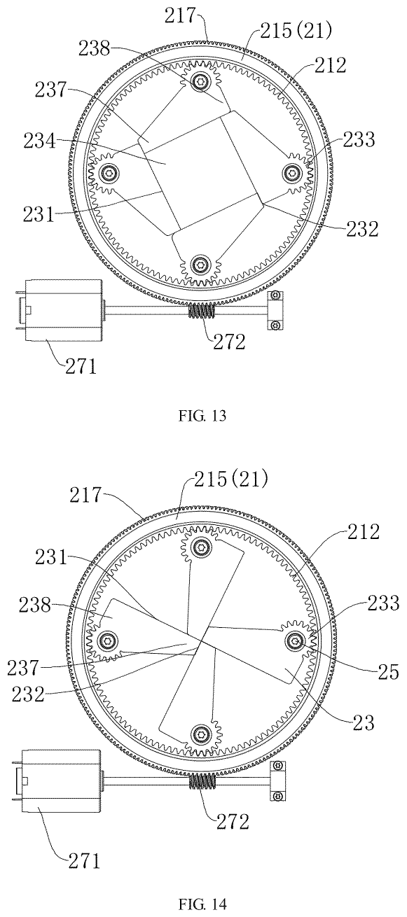

The motor 271 drives the worm 272 to rotate in the first direction and drives the rotating disk 215 to rotate relative to the fixing disk 225, and as the inner gear ring 12 meshes with the second gear portion 233 of the clamping jaw 23, the clamping jaw 23 is driven to swing around the pivot shaft 24, and the clamping cavity 234 is enlarged to the maximum, as shown in FIG. 13. When the motor 271 rotates in a second direction opposite to the first direction, the rotating disk 215 rotates reversely, so as to drive the clamping jaw 23 to rotate reversely, and narrow the clamping cavity 234 gradually to the minimum, as shown in FIG. 14.

In the clamping fixture of the present example, the motor drives the rotating disk to rotate by a pair of the worm and the worm gear to realize that the clamping cavity is enlarged and narrowed, the clamping force of the clamping jaw is large, the clamping jaw is not easy to wear out and has high accuracy, a larger size variation range of the clamping cavity, a good applicability, and is capable of automatic centering of the workpiece and improves the reliability.

A test device for testing the holding force of a contact member of a connector of an embodiment of the present disclosure is described below.

A connector is usually used to connect a wire harness and has a large variation in size. If the holding force of the contact member of the connector is insufficient, it may lead to poor contact or even interruption of connection. Therefore, it is necessary to test the holding force of the contact member of the connector.

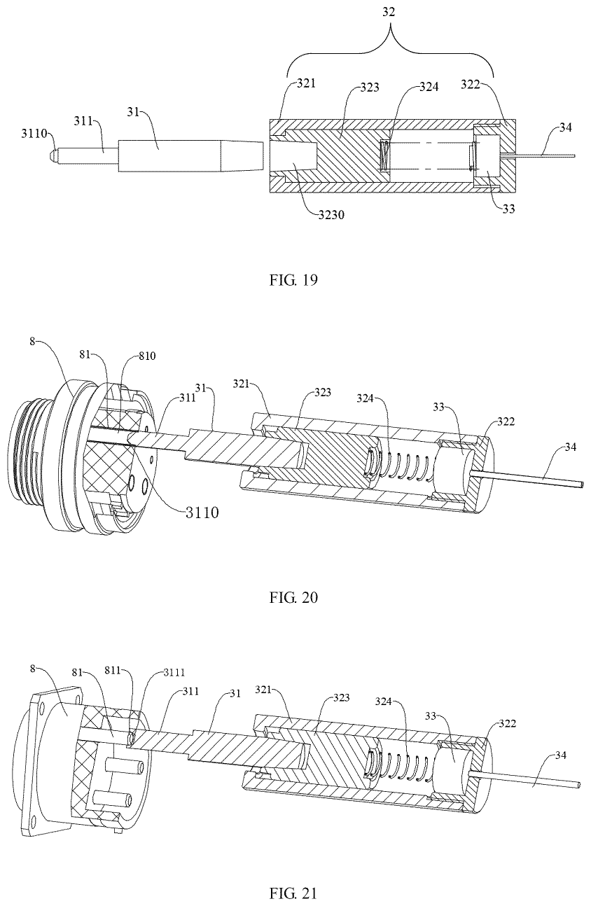

As shown in FIGS. 10-21, the test device 100 includes a machine body 1, a clamping fixture 2, and a test assembly 3.

The clamping fixture 2 includes a first support component 21, a second support component 22, and at least three clamping jaws 23. The second support component 22 is mounted to the machine body 1, and the first support component 21 is rotatably mounted to the second support component 22.

The first support component 21 has a first working through hole 211, and a peripheral wall of the first working through hole 211 has a first gear portion 212. The second support component 22 has a second working through hole 221, and a center axis of the second working through hole 221 aligns with a center axis of the first working through hole 211.

The clamping jaws 23 are pivotably mounted to the second support component 22 and are uniformly arranged along a peripheral direction of the first working through hole 211. Each clamping jaw 23 has a clamping surface 231, a butting surface 232 and a second gear portion 233. In two adjacent clamping jaws 23, a butting surface 232 of one clamping jaw 23 is adjacent to and faces a clamping surface 231 of the other clamping jaw 23, and thus a clamping cavity 234 for clamping the connector is enclosed by the clamping surfaces 231 of at least three clamping jaws 23. The section of the clamping cavity 234 may always be in the shape of a regular polygon structure that can clamp the connector of circular, polygonal or other shapes.

The first gear portion 212 meshes with the second gear portion 233, and when the first support component 21 rotates relative to the second support component 22, the at least three clamping jaws 23 rotate synchronously to enlarge or narrow the clamping cavity 234.

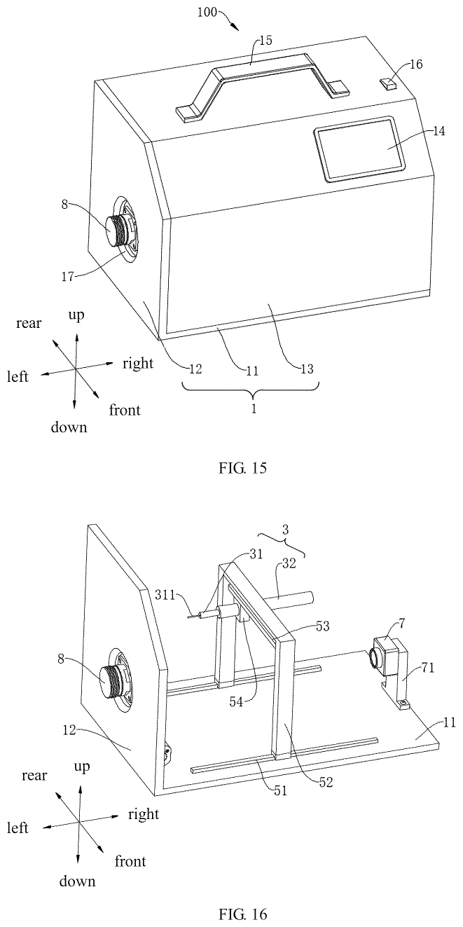

The test assembly 3 is mounted within the machine body 1 and includes a test head 31, the test head has a test probe 311 for contacting the contact member 81 of the connector 8. The test assembly 3 is movable in a first direction relative to the machine body 1 so that the test probe 311 may be contacted with and disengaged from the contact member 81 of the connector 8. The test assembly 3 is movable relative to the machine body 1 in a second direction and a third direction so that the test probes 311 aligns with a predetermined contact member 81 of the connector 8, and the first direction, the second direction, and the third direction are orthogonal to each other. For example, in FIGS. 15 and 16, the first direction is a left-right direction, the second direction is an up-down direction, and the third direction is a front-rear direction. By moving the test assembly 3 in the front-rear direction and the up-down direction, the test probe 311 and the predetermined contact member may be aligned in the left-right direction, and the test assembly 3 is driven to move in the left-right direction, the test probe 311 may be contacted with or disengaged from the predetermined contact member 81, so as to complete the test of the holding force of the contact member.

In some specific embodiments, as shown in FIGS. 10-17, the test device 100 further includes a test head storage 6, a camera 7, and a controller 141.

As shown in FIG. 15, the machine body 1 is a substantial rectangular housing. The machine body 1 includes a bottom plate 11, a side plate 12 and a shield housing 13. The side plate 12 is fixed to a left end of the base plate 11, and the shield housing 13 is buckled on the base plate 11 and connected to the side plate 12, thereby defining a mounting cavity within the machine body. The clamping fixture 2, the test assembly 3, the test head storage 6, the camera 7 and the controller 141 can be arranged within the mounting cavity of the machine body 1.

Atop surface of the shield housing 13 has a carrying handle 15 and a switch 16. The carrying handle 15 is used to handle and carry the test device 100. The switch 16 is used to control the test device 100 to be energized or de-energized. The shield housing 13 includes a touch display screen 14 for setting a test parameter, planning a test path, developing a test strategy, displaying a holding force, and maneuvering the test device 100 to complete a test, and the touch display screen 14 may be connected to the controller 141.

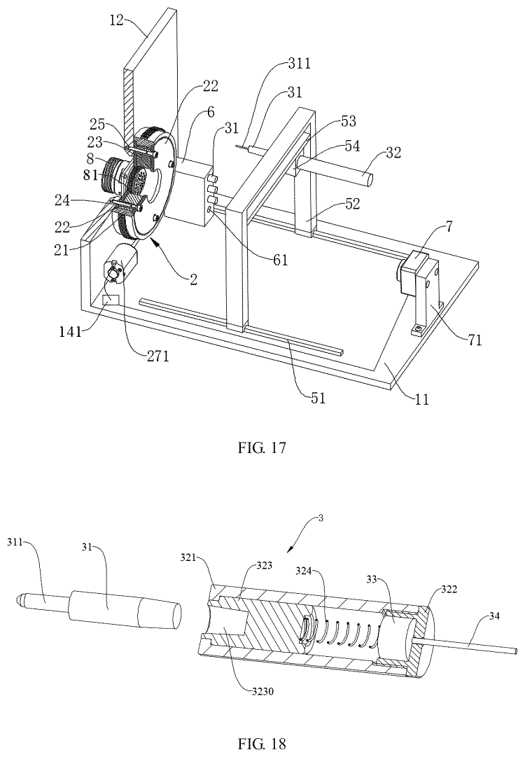

As described in FIGS. 16 and 17, a first guide rail 51, a second guide rail 52, and a third guide rail 53 are located in the mounting cavity of the machine body 1. Two first guide rails 51 are provided and arranged on the base plate 11, and two first guide rails 51 are spaced apart in the front-rear direction and extend in the left-right direction. The second guide rail 52 extends in the up-down direction and is arranged on two first guide rails 51, and the second guide rails 52 may move in the left-right direction along the first guide rail 51. The second guide rail 51 has an inverted U-shaped structure to increase the structural stability of the second guide rail 52. Optionally, the second guide rail 52 may be two separate guide rails which are movably arranged on each of two first guide rails 51 respectively. The third guide rail 53 extends in the front-rear direction. A front end and a rear end of the third guide rail 53 are connected to the second guide rail 52 respectively and are movable in the up-down direction along the second guide rail 52. The third guide rail 53 includes a slide stage 54, and the slide stage 54 is movable in the front-rear direction along the third guide rail 53.

As shown in FIGS. 16-17, the test assembly 3 is mounted on the slide stage 54 and is movable in the left-right direction, in the front-rear direction, and in the up-down direction. As shown in FIGS. 18-20, the test assembly 3 includes a teat head 31, a support main body 32, and a force measuring sensor 33. The support main body 32 includes a support housing 321, a support end cover 322, a test head sliding sleeve 323, and a buffer spring 324. The support end cover 322 is mounted to a right end of the support housing 321 to enclose that right end of the support housing 321. A force measuring sensor 33 is arranged within the support housing 321 and adjacent to the support end cover 322, the test head sliding sleeve 323 is slidably arranged within the support housing 321 along the left-right direction, and the buffer spring 324 is arranged between the force measuring sensor 33 and the test head sliding sleeve 323.

As shown in FIGS. 18-20, the contact member 81 of the connector 8 may be a female contact member having a contact member socket 810, the test probe 311 has a probe end head 3110, and the probe end head 3110 may be inserted into and withdrawn from the contact member socket 810. Optionally, as shown in FIG. 21, the contact member 81 may be a male contact member having a contact member plug 811, the test probe 311 has a probe end hole 3111, and the contact member plug 811 may be inserted into and withdrawn from the probe end hole 3111.

A left end of the test head sliding sleeve 323 has a test head fit hole 3230, and a right end of the test head 31 plugably fits within the test head fit hole 3230, so that the test head 31 is mounted to the support main body 32. A left end of the test head 31 has the test probe 311 for contacting and fitting with the contact member 81. The force measuring sensor 33 is connected to a sensor lead wire 34, and the sensor lead wire 34 passes through the support end cover 322 and extends out of the support housing 321, for example to be connected to the controller 141.

Optionally, the force measuring sensor may be arranged in other locations, as long as it is capable of detecting the thrust force exerted by the test assembly 3 on the connector 8 or a reaction force of the connector 8 on the test assembly 3.

A drive device, such as a motor or an electric actuator, may be arranged in the mounting cavity of the machine body 1 for driving the test assembly 3 to move in the left-right direction, the up-down direction and the front-rear direction, respectively. The drive device may be connected to a controller so that the controller controls the movement of the test assembly 3.

The test head storage 6 is arranged in a mounting cavity of the machine body 1. The test head storage 6 has a plurality of storage cavities 61, the plurality of storage cavities 61 are used to store a plurality of different test heads 31 for different connectors or different contact members 81 of the connector. The test assembly 3 is capable of aligning with any of the storage cavities to take out a test head from the storage cavity and to put the test head into that storage cavity. The test head storage 6 may be arranged side by side with the clamping fixture 2 within the machine body 1 to save space.

As shown in FIGS. 16 and 17, a mounting base 71 is arranged within the mounting cavity of the machine body 1, and the camera 7 is mounted to the mounting base 71 and is opposite to the clamping fixture 2 for taking a picture of the connector 8 to obtain form and size information and position information of each contact member 81 of the connector 8. The controller 141 may be connected to the camera 7 to control the movement of the test assembly 3 based on form and size information and position information obtained by the camera 7, so that the test assembly 3 selects a suitable test head from the test head storage 6 and aligns the test probe 311 with the contact member 81. The controller 141 may also be connected to a force sensor of the test assembly 3 to obtain a thrust force exerted by the test assembly 3 on the contact member 81 or a reaction force exerted by the contact member 81 on the test assembly 3. In addition, the controller 141 is also capable of grouping the contact members 81, planning a test path, and formulating a test strategy based on the obtained form and size information and position information, and then the holding forces of the plurality of contact members are sequentially tested based on the test strategy.

For example, when the contact members are grouped, the plurality of same contact members may be divided into one group. During testing, multiple contact members in the same group are tested sequentially by using a same test head. After the plurality of contact members in the same group have been tested, that one test head is placed into one storage cavity of the test head storage, and then another test head 31 is taken out of another storage cavity and sequentially tests the plurality of contact members in another group. Thereby it is able to reduce the frequency of test head replacement and improve testing efficiency.

As shown in FIG. 17, the clamping fixture 2 is mounted to the side plate 12 within the mounting cavity of the machine body 1 and is located at the inside of the side plate 12. The side plate 12 has an operation through hole 17, the connector 8 may be mounted in and removed from the clamping fixture 2 by the operation through hole 17 from outside the mounting cavity of the machine body 1 without the need to open the shield housing 13, which improves testing efficiency.

As shown in FIGS. 10-17, the clamping fixture 2 includes a rotatably rotating disk 215, two fixing disks 225, four clamping jaws 23, and a drive assembly 27.

The rotating disk 22 is a circular ring and has a circular first working through hole 211 located in the center of the circular ring. The fixing disk 225 is a circular ring and has a circular second working through hole 221 located in the center of the fixed disk and a plurality of shaft holes 226 uniformly arranged around the second working through hole 221. Two fixing disks 225 are mounted to the side plate 12, the rotating disk 22 is rotatably provided between the two fixing disks along the axis direction of the first working through hole 211 (a left-right direction in FIG. 16), and a center axis of the second working through hole 221 aligns with a center axis of the first working through hole 211.

A flared hole segment 214 is formed by enlarging the diameters of two ends of the first working through hole 211, so that an annular protrusion is formed on the middle of the peripheral wall of the first working through hole 211, an inner gear ring 212 is formed on the peripheral wall of the annular protrusion, and an outer gear ring 217 is formed on the outer peripheral wall of the rotating disk. Two fixing disks 225 fit within two flared hole segments 214 and are blocked by the annular protrusion, respectively.

As shown in FIGS. 10-12, four clamping jaws 23 are located within a first working through hole 211. The clamping jaw 23 is rotatably mounted between two fixing disks 225 by a pivot shaft 24 penetrating through a pivot hole 239. The pivot shaft 24 is a hollow shaft, and two ends of the pivot shaft 24 fit into shaft holes 226 of each of the two fixing disks, and each of the two fixing disks is mounted to the side plate 12 of the machine body 1 by a fastener 25 passing through the pivot shaft 24, such as a bolt. Moreover, the two fixing disks 225 are connected together by the fastener 25, which increases the overall structural stability.

As shown in FIG. 10, a side surface of the clamping jaw 23 is substantially trapezoidal in shape, the clamping jaw 23 has a first end 237 and a second end 238, an end surface area of the first end 237 is smaller than an end surface area of the second end 238, the end surface of the first end 237 of the clamping jaw 23 is formed as the butting surface 232, and a bottom surface of the clamping jaw 23 is formed as the clamping surface 231. The second gear portion 233 is formed at a junction of an end surface of the second end and an upper surface of the clamping jaw 23. A bottom surface of the clamping jaw 23 is a surface of the clamping jaw 23 facing the center of the rotating disk, and the upper surface is a surface of the clamping jaw 23 facing to the bottom surface.

As shown in FIGS. 10-14, the drive assembly 27 is provided within the machine body 1 and includes the motor 271 and the worm 272, one end of the worm 272 is connected to the motor 271 and the other end of the worm 272 is rotatably supported by a support base 273. The worm 272 meshes with an outer gear ring 217 of the rotating disk 22. For example, the motor 271 may drive the rotating disk 215 to rotate in the forward direction relative to the fixing disk 225 under the control of the controller 141 by the worm 272 and the inner gear ring (the worm gear) 213, and then the rotating disk 215 drives the four clamping jaws 3 to swing synchronously around the pivot shaft 24 by the inner gear ring 212 and the second gear portion 233 that mesh with each other, the clamping cavity 234 is gradually opened to the maximum, as shown in FIG. 13. When the motor 271 drives the rotating disk 215 to rotate reversely relative to the fixing disk 225 by the worm 272 and the outer gear ring 217, thereby driving the clamping jaws to rotate reversely synchronously, and the clamping cavity 234 is gradually narrowed.

A testing process of the holding force testing device 100 of the contact member of the connector of embodiments of the present disclosure is described below.

By operating the switch 16, the test device 100 is energized. By operating the touch display screen 14, the controller 141 controls the motor 271 to drive the rotating disk 215 to rotate in the forward direction, the four clamping jaws 23 swing in the forward direction synchronously, the clamping cavity 234 is gradually opened, and the connector 8 is put into the clamping cavity 234, and then the motor 271 drives the rotating disk 215 to rotate in the reverse direction, the four clamping jaws 23 swing in the reverse direction synchronously, the clamping cavity 234 is gradually narrowed, and thus the clamping jaws 23 clamp the connector.

By operating the touch display screen 14, the controller 141 activates the camera 7 to obtain position information and form and size information of the contact members, and the contact members are grouped, a test path is planned, and a test strategy is formulated, and the controller 141 controls the drive device to drive the test assembly 3 to move within the machine body 1, the support main body 32 takes out a corresponding test head 31 from the test head storage 6, and then the controller drives the test assembly 3 to move based on the position information and the form and size information of the contact member, etc., obtained by the camera 7, so that the test probe 311 contacts the contact member 81 of the connector 8, and the thrust force applied by the test assembly 3 to the contact member 81 is gradually increased, and when the thrust force reaches a preset value, the thrust force is stop applying for a period of time, and the change of the thrust force (i.e., the reaction force of the contact member on the test assembly) can be displayed by the touch display screen so as to determine whether the contact member is qualified, for example, if the thrust force appears to decay, it is indicated that the contact member has been retreated, the holding force of the contact member is insufficient, at this time, the test device can be marked as unqualified, and an alarm warning is sent out. If the thrust force does not appear to decay, the holding force of the surface contact member may reach the preset value and be marked as qualified. Then, the controller controls the test assembly to move away from the connector so that the test probe is disengaged from the contact member and the testing of that contact member is completed.

When the testing of all contact members is completed, the motor 72 drives the rotating disk 215 to rotate in the forward direction, the clamping cavity 234 is gradually increased to release the connector 8, so that the connector 8 can be removed from the clamping fixture 2.

Other operation and running of the test device of embodiments of the present disclosure are subject to operation and running strategies known by those skilled in the art and will not be repeated herein.

In the description of the present disclosure, it is to be understood that the orientation or positional relationship indicated by the terms “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise”, “counterclockwise”, “longitudinal”, “radial” and “circumferential”, etc. is based on the orientation or positional relationship shown in the accompanying drawings, which is only for the convenience of describing the present disclosure and simplifying the description, and is not intended to indicate or imply that the device or element referred to must have a particular orientation, be constructed and operated in a particular orientation, and therefore cannot be construed as a limitation of the present disclosure.

Furthermore, the terms “first” and “second” are used for descriptive purposes only and are not to be understood as indicating or implying relative importance or implicitly specifying the number of technical features indicated. Thus, a feature defined with the terms “first”, “second” may explicitly or implicitly include at least one such feature. In the description of the present disclosure, “a plurality of” means at least two, e.g., two, three, etc., unless otherwise explicitly and specifically limited.

In the present disclosure, unless otherwise expressly specified and limited, the terms “install”, “interconnect”, “connect”, “fix”, etc. shall be broadly understood, for example, it can be a fixing connection, a removable connection, or a one-piece unit; it can be a mechanical connection, an electrical connection, or a communication with each other; it can be a direct connection or an indirect connection via an intermediate medium; it can be a communication within the two elements or an interaction between the two elements, unless otherwise expressly limited. For those skilled in the art, the specific meaning of the above terms in the present disclosure may be understood on a case-by-case basis.

In the present disclosure, the terms “an embodiment”, “some embodiments”, “an example”, “a specific example”, or “some examples” mean that the specific features, structures, materials, or characteristics described in connection with the embodiment or example are included in at least one embodiment or example of the present disclosure. In this specification, schematic expressions of the above terms need not be directed to the same embodiments or examples. Moreover, the specific features, structures, materials, or characteristics described may be combined in any one or more embodiments or examples in a suitable manner. Furthermore, without contradicting each other, those skilled in the art may combine and join features of different embodiments or examples and different embodiments or examples described in this specification.

Although the above embodiments have been shown and described, it is understood that the above embodiments are illustrative and are not to be understood as limiting the embodiments of the present disclosure, and changes, modifications, substitutions, and variations made by persons skilled in the art with respect to the above embodiments are within the protection scope of the embodiments of the present disclosure.

What is claimed is:

1. A clamping fixture, comprising:
a first support component having a first working through hole, wherein a peripheral wall of the first working through hole has a first gear portion;
a second support component having a second working through hole, wherein a center axis of the second working through hole is aligned with a center axis of the first working through hole, the second support component is connected to the first support component and the first support component and the second support component is configured to rotate relative to each other; and
at least three clamping jaws, wherein each clamping jaws is rotatably connected to the second support component and uniformly arranged along a peripheral direction of the first working through hole, each clamping jaw has a clamping surface, a butting surface and a second gear portion, wherein in two adjacent clamping jaws, a butting surface of one clamping jaw is adjacent to and faces a clamping surface of another clamping surface so that the clamping surfaces of at least three clamping jaws enclose a clamping cavity configured for clamping a workpiece, wherein the first gear portion meshes with the second gear portion so that the at least three clamping jaws rotate synchronously to enlarge or narrow the clamping cavity when the first support component and the second support component rotate relative to each other.

2. The clamping fixture according to claim 1, wherein in two adjacent clamping jaws, a gap between the butting surface of one clamping jaw and the clamping surface of another clamping jaw is greater than or equal to zero and less than or equal to 5 mm.

3. The clamping fixture according to claim 1, wherein the first gear portion is an inner gear ring formed at an entire peripheral wall of the first working through hole or a plurality of inner gear ring segments spaced apart along the peripheral direction of the first working through hole, and each inner gear ring segment corresponds to a corresponding second gear portion.

4. The clamping fixture according to claim 1, wherein the number of the clamping jaws is 3 to 6.

5. The clamping fixture according to claim 1, wherein the first support component comprises a fixed base, the second support component comprises two pivoting arms, the two pivoting arms are rotatably mounted on the base and respectively located at two sides of the base along an axial direction of the first working through hole, and each clamping jaw is rotatably mounted between the two pivoting arms by a corresponding pivot shaft.

6. The clamping fixture according to claim 5, wherein each of two ends of the first working through hole has an enlarged diameter to form a flared hole segment, each pivoting arm has a corresponding flange surrounding the second working through hole, each flange is rotatably fitted within a corresponding flared hole segment directly or by a bearing, and each pivot shaft penetrates through a corresponding clamping jaw and each flange of the two pivoting arms.

7. The clamping fixture according to claim 6, wherein each clamping jaw has a substantially T-shaped structure and comprises a clamping head portion and a shank portion, one end of the shank portion is connected to a rear surface of the clamping head portion, the second gear portion is arranged at another end of the shank portion, each of two ends of the clamping head portion is located within a corresponding second working through hole of each of the two pivoting arms, the shank portion has a pivot hole fitted with the corresponding pivot shaft, an end surface of the clamping head portion is a substantially trapezoidal, a front surface of the clamping head portion away from the shank portion is formed as the butting surface, and a bottom surface of the clamping head portion is formed as the clamping surface.

8. The clamping fixture according to claim 1, wherein the first support component is a rotatable rotating disk, the second support component comprises two fixed fixing disks, the rotating disk is rotatably provided between the two fixing disks along an axial direction of the first working through hole, and each clamping jaw is rotatably mounted between two fixing disks by a corresponding pivot shaft.

9. The clamping fixture according to claim 8, wherein each of two ends of the first working through hole has an enlarged diameter to form a flared hole segment, each of the two fixing disks is respectively fitted within a corresponding flared hole segment, a side surface of each clamping jaw is a substantially trapezoidal, each clamping jaw has a first end and a second end, an end surface area of the first end is less than an end surface area of the second end, an end surface of the first end of each clamping jaw is formed as the butting surface, and a bottom surface of each clamping jaw is formed as the clamping surface.

10. The clamping fixture according to claim 8, wherein the clamping fixture further comprises a base plate and a drive assembly for driving the rotating disk to rotate, the pivot shaft is a hollow shaft, two ends of the pivot shaft are connected to the two fixing disks respectively, each fixing disk is mounted to the base plate by a fastener penetrating through the fixing disk and the pivot shaft, the drive assembly comprises a motor and a worm connected to the motor, and the rotating disk has an outer gear ring meshed with the worm at an outer peripheral wall of the rotating disk.
